(19) United States
(12) Patent Application Publication
(10) Pub. No.: US 2011/0227557 A1
(43) Pub. Date: Sep. 22, 2011

(54) HIGH-VOLTAGE SWITCHING HOT-SWAP CIRCUIT

(76) Inventor: Samuel M. Babb, Fort Collins, CO (US)

(21) Appl. No.: 12/725,122

(22) Filed: Mar. 16, 2010

(51) Int. Cl. H02M 3/156

(52) U.S. Cl. 323/351

(57) ABSTRACT

Electronic circuits and methods are provided for use in high-voltage, hot-swappable circuit board applications. A pulse-width modulated (PWM) signal biases a switching transistor by way of transformer coupling. The switching transistor operates to charge an inductor. A shut-down transistor is biased to drive the switching transistor into a non-conductive state. Inductor discharge through a diode is sensed and used in generating respective biasing signals. Switching transistor stress, heating and energy wastage are significantly reduced during circuit start-up.

### BACKGROUND

Computer servers, process control instrumentation and other electronic systems are increasingly based on the use of hot-swappable circuit boards and cards. Under an ideal hot-swappable architecture, boards or cards may be removed from and installed in a supporting backplane without power-down or significant interruptions in the operation of the system as a whole. This makes hot-swappable design desirable in various redundant and/or critical application scenarios.

Numerous such hot-swappable cards require regulated power of one-hundred volts or more for normal operation. The power regulating (or input) transistors in known designs undergo considerable stress and heating, particularly during start-up transients. Energy waste and reduced operating life spans often result. The present teachings are directed to the foregoing and other related concerns.

### BRIEF DESCRIPTION OF THE DRAWINGS

The present embodiments will now be described, by way of example, with reference to the accompanying drawings, in which:

FIG. 1 depicts a block diagram of a system according to one embodiment.

FIG. 2 is a flow diagram depicting a method according to one embodiment;

FIG. 3 is a schematic diagram depicting switching regulator circuitry according to one embodiment;

FIG. 4 is a signal timing diagram according to one embodiment;

FIG. 5 is a flow diagram depicting a method according to one embodiment.

### DETAILED DESCRIPTION

### Introduction

Electronic circuits and methods are provided for use in high-voltage, hot-swappable circuit board applications. A pulse-width modulated (PWM) signal is used to bias a switching transistor by way of transformer coupling. The switching transistor operates to charge an inductor. A shut-down transistor is used to drive the switching transistor into a non-conductive state. The inductor discharges through a diode. The state of inductor discharge is sensed and used in generating respective biasing signals. Switching transistor stress, heating and energy wastage are significantly reduced during circuit start-up.

In one embodiment, an electronic circuit includes an inductor and a first transistor. The first transistor is configured to charge the inductor from a source of electrical energy while in a conductive state. The first transistor is also configured to be biased into the conductive state in accordance with a first signal. The electronic circuit includes a second transistor configured to bias the first transistor into a non conductive state in accordance with a second signal. Additionally, the electronic circuit includes a controller configured to provide the first signal to the first transistor by way of transformer coupling. The controller is also configured to provide the second signal to the second transistor by way of transformer coupling.

In another embodiment, a method includes biasing a switching transistor into a conductive state for a first time period. The method also includes biasing the switching transistor into a non-conductive state by way of a shut-down transistor. The method additionally includes detecting a fully discharged state of an inductor by way of sensing circuitry coupled to a diode. The method further includes biasing the switching transistor into the conductive state for a second time period.

### First Illustrative System

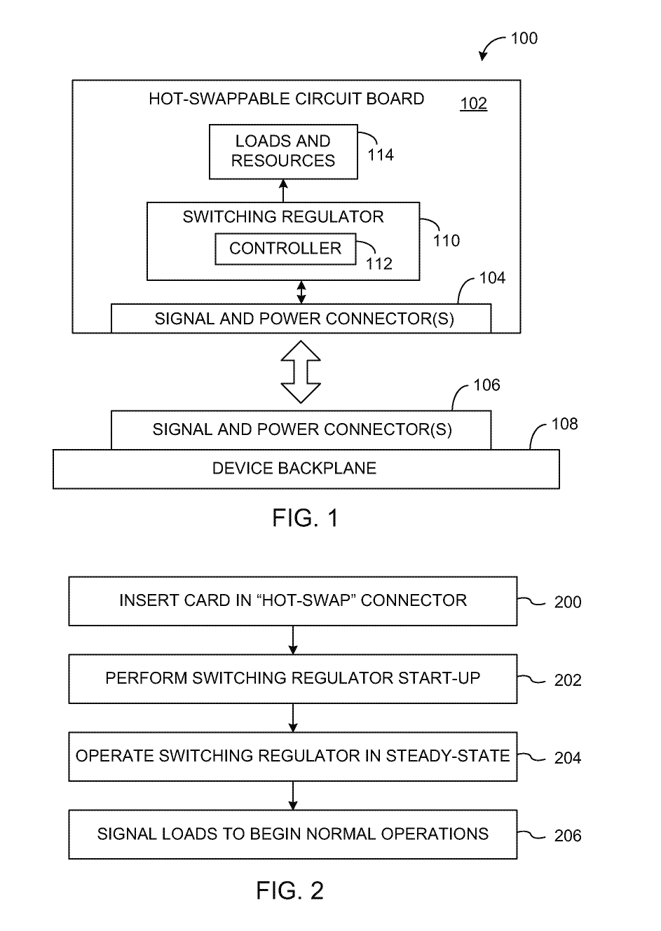

Reference is now directed to FIG. 1, which depicts a block diagram of a system 100. The system 100 is illustrative and non-limiting with respect to the present teachings. Thus, other systems can be configured and/or operated in accordance with the present teachings.

The system 100 includes a hot-swappable circuit board (HSCB) 102. The HSCB 102 includes one or more electrical connectors 104 that are configured to electrically engage one or more corresponding connectors 106 of a device backplane 108. Electrical power and various electrical signals can be communicated between the HSCB 100 and other resources by way of the electrical connectors 104 and 106.

The HSCB 102 also includes switching regulator 110 according to the present teachings. The switching regulator 110 is coupled to the connector 104 so that electrical ground, power and various signals can be used, communicated or monitored in accordance with the present teachings. The switching regulator 110 is also in power and signal communication with other resources of the HSCB 102 as described hereinafter. The switching regulator 110 is configured to receive unregulated high-voltage direct-current (DC) power by way of the backplane 108 and to provide a regulated high-voltage DC output.

The switching regulator 110 also includes a switching controller 112. The controller 112 is coupled to control various normal operations of the switching regulator 110. Notably, the controller 112 is configured to control start-up and ongoing operation of the switching regulator in accordance with the present teachings.

The HSCB 102 further includes other resources 114 in accordance with the normal application and use of the HSCB 102. Non-limiting examples of such other resources 114 include one or more microprocessors, state machines, analog circuitry, digital circuitry, hybrid circuitry, application-specific integrated circuits (ASICs), solid-state memory, field-programmable gate arrays (FPGAs) data storage devices, wireless circuitry or devices, etc. In other words, numerous hot-swappable circuit boards 102 can be configured and directed to respectively different applications in accordance with the present teachings. The particular other resources 114 and their respective normal operations are not germane to the present teachings and further elaboration is not required. Typical normal operations of the HSCB 102 are described below.

### First Illustrative Method

FIG. 2 is a flow diagram depicting a method according to one embodiment of the present teachings. The method of FIG. 2 includes particular operations and order of execution. However, other methods including other operations, omitting one or more of the depicted operations, and/or proceeding in other orders of execution can also be used according to the present teachings. Thus, the method of FIG. 2 is illustrative and non-limiting in nature. Reference is also made to FIG. 1 in the interest of understanding the method of FIG. 2.

At 200, a hot-swappable circuit card is inserted into a connector (or connectors) of a backplane. For purposes of non-limiting illustration, it is assumed that a hot-swappable circuit board 102 is inserted into (electrically mated to) a connector 106 of an energized and operating backplane 108. As such, the switching regulator 110 is electrically coupled to unregulated high-voltage DC power (e.g., three-hundred volts, etc.).

At 202, switching regulator start-up is performed. For purposes of the ongoing illustration, it is assumed that the switching controller 112 controls various operations of the switching regulator 110 so as to transition toward and operate at steady-state conditions. The start-up phase includes driving one or more switching (i.e., input, or pass) transistors of the switching regulator 110 by way of pulse-width modulated (PWM) signaling, so as to linear ramp the regulated output voltage from zero toward a normal operating value.

At 204, the switching regulator is operated in steady-state. For purposes of the ongoing illustration, the start-up phase (transient) of 202 above is complete, and the switching regulator 110 is now providing a regulated high-voltage DC output (e.g., two-hundred eighty volts, etc.). This steady-state operation continues under the influence of controller 112.

At 206, various loads are signaled to begin normal operations. For purposes of illustration, the switching controller 112 provides one or more status signals to the loads and resources 114 indicating normal, steady-state operation of the switching regulator 110. In turn, various loads and subsystems of the HSCB 102 begin normal operations while being supplied regulated operating power by way of the switching regulator 110.

The foregoing method is illustrative of any number of methods contemplated by the present teachings. In general, and without limitation, a hot-swappable circuit board is coupled to one or more corresponding connectors of a system backplane or other architecture. A switching controller causes a switching regulator to transition a regulated output voltage toward a final, steady-state operating value in a generally linear-ramping manner. However, such ramping need not be linear in nature. The present teachings contemplate transition of the regulated output voltage in accordance with other time-rate-of-change patterns (e.g., non-linear, multiple step-wise, logarithmic, etc.).

PWM signals are used to drive one or more switching transistors of the switching regulator during the start-up phase. Feedback signals from voltage output and other nodes within the switching regulator are sensed by the controller during the driving of the switching transistor(s). Once the start-up transient is complete, loads and subsystems are signaled by the controller to begin normal operations. The switching regulator continues to be operated in a steady-state output mode in accordance with the switching controller (e.g., 100% duty cycle).

### First Illustrative Embodiment

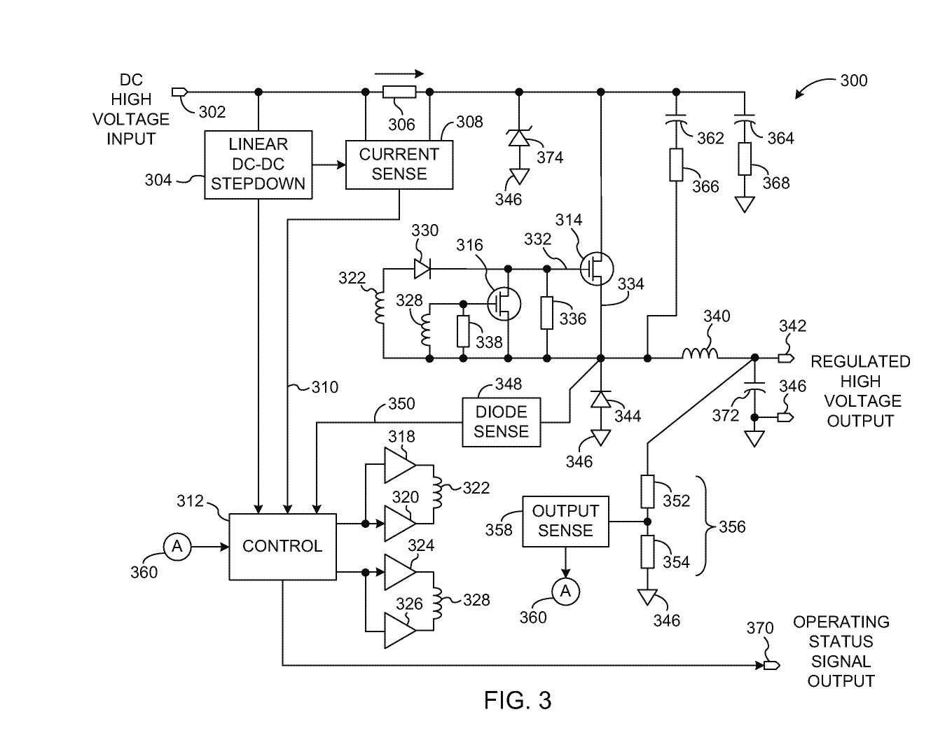

Attention is now turned to FIG. 3, which depicts a schematic diagram of electronic circuitry 300 according to one embodiment. The circuitry 300 is illustrative and non-limiting with respect to the present teachings. The circuitry 300 is also understood to comprise at least a portion of the switching regulator 110 according to one embodiment. Thus, the circuitry 300 is also referred to as a switching regulator 300. Other switching regulators are also contemplated by the present teachings.

The circuitry 300 includes a power input node 302. The node 302 is configured to be coupled to a source of unregulated, high-voltage DC energy. In one embodiment, the node 302 is coupled to three-hundred eighty volts DC. Other voltages can also be used.

The circuitry 300 also includes a linear DC-to-DC step-down regulator (linear regulator) 304. The linear regulator 304 is configured to receive high-voltage energy at the node 302 and to provide one or more regulated DC outputs of substantially reduced voltage value (e.g., three-point-three volts, etc.) The linear regulator 304 can be inclusive of, or defined by, any suitable circuitry, electronic components, integrated circuits, etc., as desired. One having ordinary skill in the electrical and related arts can appreciate that various known circuits can be used, and further elaboration on the linear regulator 304 is not required for an understanding of the present teachings.

The circuitry 300 further includes a current sensing element 306. The current sensing element 306 can be defined by a resistor or other suitable element characterized by a linear voltage drop in accordance with the current flowing there through. Other suitable elements and devices can also be used. The circuitry 300 also includes current sense circuitry 308 coupled across the sensing element 306. The current sense circuitry 308 is configured to provide an output signal at a node 310 in accordance with the current flow sensed by way of element 306. The signal at node 310 can be analog, digitized, etc., as desired. In one embodiment, the current sense circuitry 308 includes a model LT6107 Current Sense Amplifier, as available from Linear Technology Corporation, Milpitas, Calif., USA. Other suitable components, devices or circuits can also be used.

The circuitry 300 also includes a switching controller 312. The controller 312 is configured to control various normal operations of the electronic circuitry (switching regulator) 300. The controller 312 is also configured to receive operating power from the linear regulator 304, and various signals including the current sense signal at node 310. Other signals provided to the controller 312 will be described hereinafter.

The controller 312 is further configured to provide biasing (i.e., drive) signals to a switching transistor 314 and a shut-down transistor 316, respectively, of the switching circuitry 300. Specifically, the controller 312 provides a pulse-width modulated biasing signal to the switching transistor 314 by way of respective amplifiers 318 and 320, and coupling transformer 322. In turn, the controller 312 provides a pulsed biasing signal to the shut-down transistor 316 by way of respective amplifiers 324 and 326, and coupling transformer 328. Further elaboration on these respective biasing signals is provided hereinafter.

The controller 312 can include, or be defined by, any suitable circuitry, integrated circuits, microprocessor or microcontroller, etc., as desired. In one embodiment, the controller 312 includes a programmable logic device.

The circuitry 300 includes the switching transistor 314 introduced above. The switching transistor 314 is configured to receive a biasing signal from the controller 312 by way of the transformer 322 and a diode 330. A control node (i.e., gate) 332 and an output node (i.e., source) 334, respectively, of the switching transistor 314 are coupled together by way of a biasing resistor 336. The circuitry 300 further includes the shut-down transistor 316 introduced above. The shut-down transistor 316 is configured to receive a biasing signal from the controller 312 by way of the transformer 328. A biasing resistor 338 is also coupled across the secondary side of the transformer 328.

The circuitry 300 also includes an energy storage inductor (inductor) 340. The inductor 340 is configured to be coupled to electrical energy provided at the node 302 by way of the switching transistor 314. In turn, the inductor 340 is coupled to provide regulated high-voltage DC power at an output node 342. The circuitry further includes a diode 344. The diode 344 is configured to electrically discharge the inductor 340 to ground (node or plane) 346 when the switching transistor 314 is in a non-conductive state.

The circuitry 300 also includes diode sense circuitry 348. The diode sense circuitry 348 is coupled to sense the instantaneous voltage across the diode 344 by way of the node 334. In turn, the diode sense circuitry 348 provides a signal at a node 350 corresponding to the instantaneous charged or discharged state of the inductor 340. The diode sense circuitry 348 can include an amplifier, buffer, voltage divider or other suitable circuitry. The controller 312 is coupled to receive the inductor status signal provided at the node 350.

The circuitry 300 also includes a resistor 352 and a resistor 354, configured to define a voltage divider 356. The voltage divider 356 is coupled to the output node 342 and to the ground node 346. The voltage divider 356 provides a reduced voltage-representative of the high-voltage DC output of the switching regulator 300. Output sense circuitry 358 monitors the voltage divider 356 and provides a corresponding signal to the controller 312 by way of a node 360. The output sense circuitry 358 can include an amplifier, buffer or other suitable circuitry configured to scale or otherwise process the signal being provided to the controller 312. The signal provided at the node 360 is also referred to as an output feedback signal for purposes herein.

The circuitry 300 also includes respective capacitors 362 and 364, and respective resistors 366 and 368. The elements 362-368, inclusive, are configured to attenuate (or dampen) oscillations (“ringing”) that can occur within the circuitry 300. The controller 312 is further configured to provide a status signal at a node 370, indicative of the instantaneous operating state of the switching regulator 300. The signal at the node 370 can indicate a start-up transient condition, steady-state operating condition, or other status of the switching regulator 300. The circuitry 300 also includes output filter capacitor 372 coupled between respective nodes 342 and 346. The circuit 300 further includes a clamping diode 374 coupled to ground node 346.

In general and without limitation, the switching regulator (circuitry) 300 operates to receive unregulated high-voltage DC power at node 302 and to provide a regulated high-voltage DC output at node 342. The controller 312 operates to control numerous normal operations of the circuitry 300. In particular, the controller 312 drives the switching transistor 314 by way of transformer coupled, pulse-width modulated signaling. Additionally, the controller 312 drives a shut-down transistor 316 by way of transformer coupled signaling. The shut-down transistor 316 is configured to assertively bias (i.e., drive or clamp) the switching transistor 314 into an electrically non-conductive state.

The respective bias signals provided to the switching transistor 314 and the shut-down transistor 316 are asserted out-of-phase with each other. That is, shut-down transistor 316 biasing is not asserted while the switching transistor 314 biasing is asserted, and vice versa. The instantaneous charge or discharge state of the storage inductor 340 is monitored by way of the diode 344 and a corresponding signal is provided to the controller 312.

The controller 312 uses the inductor 340 discharge state signal for purposes of generating and synchronizing the respective switching transistor 314 and shut-down transistor 316 biasing signals. Feedback signaling at node 360, representing the regulator voltage output at node 342, is also provided to and used by the controller 312.

Table 1 below provides illustrative and non-limiting values and identifications for components of the circuitry 300 according to one embodiment. One having ordinary skill in the electrical and related arts can appreciate that other suitable components or element values, or additional components, can also be used:

TABLE 1
Illustrative Switching Regulator 300

| Element/Device | Value/Model | Notes/Vendor |
|---|---|---|
| Linear Reg. 304 | LR8 | Supertex Inc. |
| Resistor 306 | 0.7 m Ohms | 0.1%/(any vendor) |
| Current Sense 308 | LT6107 | Linear Technology Corp. |
| Controller 312 | CPLC | any vendor |
| Transistor 314 | 600 V 0.73 Ohm | Fairchild Semiconductor |
| Transistor 316 | 30 V 0.065 Ohm | Fairchild Semiconductor |
| Buffer/Amp. 318 | UCC37323D | Texas Instruments |
| Buffer/Amp. 320 | UCC37323D | Texas Instruments |
| Transformer 322 | Gate Drive | Coilcraft/Pulse Engineer |
| Buffer/Amp. 324 | UCC37323D | Texas Instruments |
| Buffer/Amp. 326 | UCC37323D | Texas Instruments |
| Transformer 328 | Gate Drive | Coilcraft/Pulse Engineer |
| Diode 330 | BAV99 | any vendor |
| Resistor 336 | 1000 Ohms | 10%/(any vendor) |
| Resistor 338 | 100 Ohms | 10%/(any vendor) |
| Inductor 340 | 47 uHenries | 3.3A/0.089 Ohms |
| Diode 344 | 800 V | ON semiconductor |
| Diode Sense 348 | HS Comparator | Linear Technology Corp |
| Resistor 352 | 1000 Ohms | 1%/(any vendor) |
| Resistor 354 | 1000 Ohms | 1%/(any vendor) |
| Output Sense 358 | LM324 | Any Vendor |
| Capacitor 362 | 1 uFarads | Any Vendor |
| Capacitor 364 | 1 uFarads | Any Vendor |
| Resistor 366 | 10 Ohms | 10%/(any vendor) |
| Resistor 368 | 100 Ohms | 10%/(any vendor) |
| Capacitor 372 | 4000 uFarads | Very low ESR (any vendor) |
| Diode 374 | SMCJ400A | Littelfuse |

### Illustrative Signaling

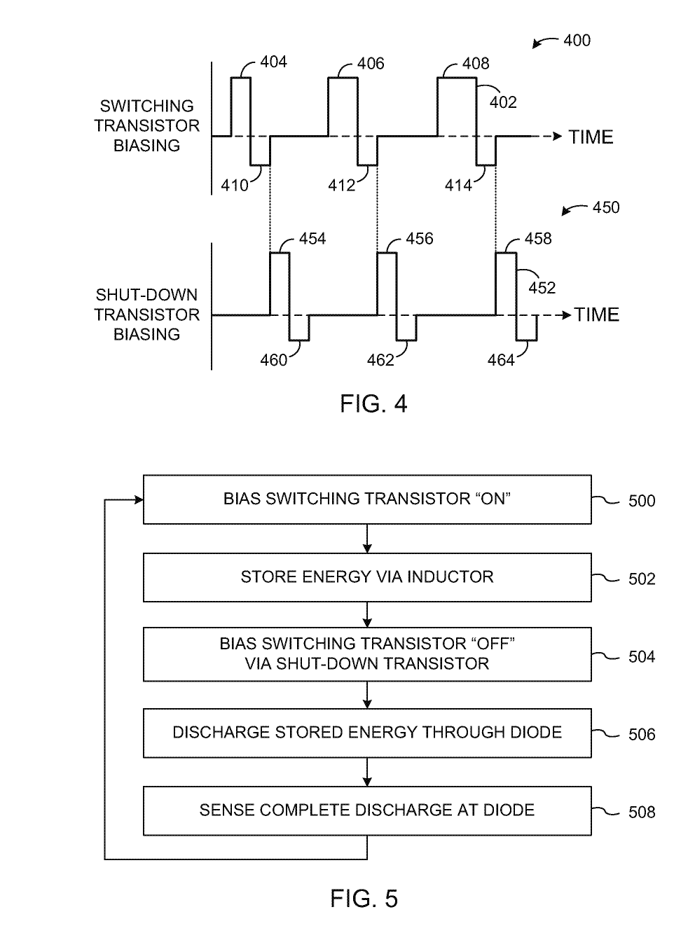

Attention is now turned to FIG. 4, which depicts respective signal timing diagrams 400 and 450 in accordance with the present teachings. The signal timing diagrams 400 and 450 are illustrative and non-limiting in nature, and are provided in the interest of understanding the present teachings. Other signal timing schemas can also be used in accordance with the present teachings. Reference is also made to FIG. 3 in the interest of understanding FIG. 4.

The signal timing diagram 400 includes a pulse-width modulated (PWM) biasing signal 402. The PWM signal 402 is generated by a suitable controller (e.g., controller 312, etc.) and is provided to a switching transistor (e.g., transistor 314, etc.) by way of transformer isolated coupling. It is noted that the portion of the PWM signal 402 depicted in FIG. 4 is increasing in duty cycle with time and corresponds to a ramping of a regulated output voltage (e.g., node 342) during start-up. Such a switching transistor is conductive (saturated, or nearly so) during positive pulses 404, 406 and 408, inclusive.

The PWM signal 402 also characterized by negative pulses 410, 412 and 414, inclusive. The switching transistor is non-conductive during negative pulses 410-414. Additionally, any charge stored within the control node (i.e., gate) of the switching transistor is rapidly discharged by way of the negative pulses 410, 412 and 414. It is noted that each period of the pulsed signal 402 is characterized by a pulse of a first polarity, followed by a pulse of a second, opposite polarity.

The signal timing diagram 400 includes a pulsed biasing signal 452. The pulsed signal 452 is generated by a suitable controller (e.g., controller 312, etc.) and is provided to a shut-down transistor (e.g., transistor 316, etc.) by way of transformer isolated coupling. Such a shut-down transistor is conductive (saturated, or nearly so) during positive pulses 454, 456 and 458, inclusive. The shut-down transistor is configured to assertively drive the switching transistor into a non-conductive state during the positive pulses 454, 456 and 458.

The pulsed signal 452 also characterized by negative pulses 460, 462 and 464, inclusive. The shut-down transistor is non-conductive during the negative pulses 460-464. Additionally, any charge stored within the control node (i.e., gate) of the shut-down transistor is rapidly discharged by way of the negative pulses 460, 462 and 464. In this way, each period of the pulsed signal 452 is characterized by a pulse of a first polarity, followed by a pulse of a second, opposite polarity.

It is noted that the respective signals 402 and 452 are synchronized to be out-of-phase with each other. That is, the signal 402 is not asserted during assertion of the signal 452, and vice versa. For non-limiting example, the positive pulse 454 of the signal 452 is not asserted until the negative pulse 410 of signal 402 is terminated, and so on.

It is further noted that positive pulses 454-458 of the signal 452 are asserted immediately after each respective negative pulse 410-414 of the signal 402. In this way, signal timing is closely controlled so as to toggle the switching transistor between conductive and non-conductive states as rapidly as possible in the interest of minimized heating and reduced energy wastage. Sensing the charged or discharged state of the energy storage inductor by way of the discharge diode is part of this signal timing stratagem.

### Second Illustrative Method

FIG. 5 is a flow diagram depicting a method according to one embodiment of the present teachings. The method of FIG. 5 includes particular operations and order of execution. However, other methods including other operations, omitting one or more of the depicted operations, and/or proceeding in other orders of execution can also be used according to the present teachings. Thus, the method of FIG. 5 is illustrative and non-limiting in nature. Reference is also made to FIGS. 3-4 in the interest of understanding the method of FIG. 5.

At 500, a switching transistor is biased “ON”. For purposes of non-limiting example, it is assumed that the switching transistor 314 of circuitry 300 is driven into a conductive state by way of positive pulse 404 of PWM signal 402. The controller 312 provides the PWM signal 402.

At 502, energy is stored within an inductor. For purposes of the ongoing example, it is assumed that electrical current is coupled to flow through the inductor 340 by way of switching transistor 314. Thus, energy is effectively stores by way of the magnetic field about the inductor 340. This step occurs while the positive pulse 404 is asserted.

At 504, the switching transistor is biased “OFF” by way of a corresponding shut-down transistor. For purposes of the ongoing example, it is assumed that the switching transistor 314 is subject to the negative pulse 410. Immediately thereafter, the shut-down transistor 316 is then biased into a conductive state by way of the positive pulse 454 of signal 452. This sequence of events rapidly drives the switching transistor 314 into a non-conductive state, shutting off the flow of electrical current to the inductor 340. The controller 312 provides the PWM signal 402 and the biasing signal 452.

At 506, energy stored within the inductor is discharged through a corresponding diode. For purposes of the ongoing example, it is assumed that the energy stored in the inductor 340 is discharged by way of current flow through the diode 344 to ground. This step occurs while the respective pulses 410, 454 and 460 are asserted. The inductor 340 is then assumed to be fully discharged.

At 508, complete discharge is sensed at the diode. For purposes of the ongoing example, it is assumed that the fully discharged state of the inductor 340 is sensed by way of voltage across the diode 344. A corresponding status signal is provided to the controller 312 by way of diode sense circuitry 348. The charge and discharge of the inductor 340 is complete for one operating cycle, and the method returns to 500 above for the next cycle. This method is repeated so as to linearly ramp the output voltage at node 342 from zero to steady-state operation.

The foregoing method is illustrative of any number of methods contemplated by the present teachings. In general, and without limitation, a high-voltage switching regulator is controlled so as to start-up from zero output voltage to steady-state operation. A switching transistor selectively switched pulses of electrical current to a storage inductor under PWM biasing. A shut-down transistor and signal synchronization are used to rapidly toggle the switching transistor between conductive (“ON”) and non-conductive (“OFF”) operating states.

The fully discharged state of the storage inductor is detected by way of a discharge diode voltage drop and corresponding signaling is provided to the controller. In turn, the controller uses this signal as well as output voltage feedback signaling to closely control the amplitude, timing and synchronization of the respective biasing signals. Such operation reduced heating of the switching transistor and the energy wastage associated therewith.

In general, the foregoing description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

What is claimed is:

1. An electronic circuit, comprising:
an inductor and a first transistor, the first transistor configured to charge the inductor from a source of electrical energy while in a conductive state, the first transistor also configured to be biased into the conductive state in accordance with a first signal;
a second transistor configured to bias the first transistor into a non-conductive state in accordance with a second signal;
a controller configured to provide the first signal to the first transistor by way of transformer coupling, the controller also configured to provide the second signal to the second transistor by way of transformer coupling.

2. The electronic circuit according to claim 1 further comprising a diode configured to discharge the inductor to a ground plane when the first transistor is in the non-conductive state, the electronic circuit configured to provide a third signal corresponding to a discharge state of the inductor to the controller.

3. The electronic circuit according to claim 1, the second transistor further configured to couple a control node of the first transistor to an output node of the first transistor during the biasing into the non-conductive state.

4. The electronic circuit according to claim 1, the controller further configured such that the first signal is defined by a pulse-width modulated signal.

5. The electronic circuit according to claim 1, the controller further configured such that the first signal and the second signal are not contemporaneously asserted.

6. The electronic circuit according to claim 1, the controller further configured such that the first signal is characterized by a sequence of periods, each period being characterized by a pulse of a first polarity followed by a pulse of a second polarity opposite the first polarity.

7. The electronic circuit according to claim 1, the electronic circuit being at least a portion of a hot-swappable circuit board.

8. The electronic circuit according to claim 1, the electronic circuit configured to provide a regulated output voltage, the electronic circuit further configured to provide a third signal corresponding to the regulated output voltage to the controller.

9. The electronic circuit according to claim 1, the controller further configured to provide at least one output signal corresponding to an operating status of the electronic circuit.

10. A method, comprising:
biasing a switching transistor into a conductive state for a first time period;
biasing the switching transistor into a non-conductive state by way of a shut-down transistor;
detecting a fully discharged state of an inductor by way of sensing circuitry coupled to a diode; and
biasing the switching transistor into the conductive state for a second time period.

11. The method according to claim 10 further comprising charging the inductor from a source of electrical energy while the first transistor is biased into the conductive state.

12. The method according to claim 10 further comprising discharging the inductor through the diode while the first transistor is biased into the non-conductive state.

13. The method according to claim 10 further comprising:
providing a first biasing signal to the switching transistor by way of transformer coupling; and
providing a second biasing signal to the shut-down transistor by way of transformer coupling.

14. The method according to claim 13, the first biasing signal and the second biasing signal being not contemporaneously asserted.

15. The method according to claim 1, the first time period and the second time period corresponding to respective pulses of a pulse-width modulated signal.
